(19) United States
(12) Patent Application Publication
(10) Pub. No.: US 2013/0255318 A1
(43) Pub. Date: Oct. 3, 2013

(54) PROCESS AND APPARATUS FOR MANUFACTURING POLYCRYSTALLINE SILICON INGOTS

(71) Applicants: Stephan Hussy, Nurnberg (DE); Oleksandr Prokopenko, Ulm (DE); Ralf Kloos, Erbach (DE); Christian Hoess, Munchen (DE)

(72) Inventors: Stephan Hussy, Nurnberg (DE); Oleksandr Prokopenko, Ulm (DE); Ralf Kloos, Erbach (DE); Christian Hoess, Munchen (DE)

(73) Assignee: CENTROTHERM SITEC GMBH, Blaubeuren (DE)

(21) Appl. No.: 13/703,654

(22) PCT Filed: Jun. 10, 2011
(86) PCT No.: PCT/EP11/02857

§ 371 Date: Jun. 4, 2013

(30) Foreign Application Priority Data
Jun. 16, 2010 (DE) 10 2010 024 010.9
Jul. 21, 2010 (DE) 10 2010 031 819.1

(51) Int. Cl. C01B 33/021; F27B 14/20; F27B 14/06

(52) U.S. Cl. CPC C01B 33/021; F27B 14/06; F27B 14/20
USPC 65/84; 65/356

(57) ABSTRACT

A process and apparatus for producing polycrystalline silicon ingots. A crucible is arranged in a process chamber and filled with solid silicon material. At least one diagonal heater is located laterally offset to and generally above the silicon ingot to be produced. The silicon material is heated to form molten silicon in the crucible, and thereafter cooled down below the solidification temperature of the molten silicon. A temperature profile in the silicon material during the cooling phase is controlled at least partially via the at least one diagonal heater. The apparatus includes a process chamber, a crucible holder, and at least one diagonal heater. The diagonal heater is located laterally with respect to the crucible holder and generally above a polycrystalline silicon ingot to be formed in the crucible. The diagonal heater is stationary with respect to the crucible holder when the process chamber is closed.

### RELATED APPLICATION

This application corresponds to PCT/EP2011/002857, filed Jun. 10, 2011, which claims the benefit of German Applications Nos. 10 2010 024 010.9, filed Jun. 16, 2010 and 10 2010 031 819.1, filed Jul. 21, 2010, the subject matter of which is incorporated herein by reference in its entirety.

### FIELD OF THE INVENTION

The present invention relates to a process and an apparatus for manufacturing polycrystalline, silicon ingots.

### BACKGROUND OF THE INVENTION

in the arts of semi-conductors and solar cells, it is known to manufacture polycrystalline silicon ingots by melting high purity silicon material in a melting vessel or crucible. As an example, a document DE 199 34 94 032 describes a corresponding apparatus for this purpose. The apparatus generally consists of an isolated box having the heating elements, a crucible, and a loading unit, located in the isolated box. Bottom heaters arranged below the crucible, lateral heaters arranged on the sides of the crucible, and top heaters arranged above the crucible are provided as heating elements.

During manufacturing of the silicon ingots, the crucible is being loaded while the isolated box is open, and thereafter, granulated silicon is fused by the heating elements in the crucible, wherein the isolated box is closed. After reloading of additional silicon material via a corresponding reloading unit, the molten material is cooled down in a controlled manner in order to provide a directed solidification from the lower part to the upper part.

In this regard, the phase boundaries between the molten material and the solidified boundary should be as fiat as possible, which is achieved by a corresponding adjustment of the temperature profile in the molten-solid part of the material. In this regard, interaction between the bottom heater and the opposing top heater is adapted to provide for a flat form of the phase boundary, since these heaters enable a generally vertically extending uniform temperature gradient because of the position. Temperature lost at the lateral sides of the crucible may be compensated/minimized via the lateral heaters or an appropriate thermal isolation.

For certain applications, such as described in the not previously published DE 10 2010 024 010, it is useful, however, to keep a free space above the crucible. Thus, it is not always possible or reasonable to use a top heater.

Thus, a controlled cooling of the molten material in the crucible is accomplished via a corresponding control of the bottom heater and/or the lateral heater, arranged adjacent to the crucible, without assistance to our top heaters. In case only the bottom heater is used, a desirable control over the temperature profile may not be achieved, since solidification shall take place from the bottom to the top, as mentioned above. On the other side, the use of the lateral heaters results in a substantive curvature of the phase boundary during the orientated solidification.

Starting from the known apparatus, the problem to be solved by the invention is, to provide an apparatus and a process for manufacturing polycrystalline silicon ingots, which allow for a good control of the phase boundary.

### SUMMARY OF THE INVENTION

According to the invention, a process for producing a polycrystalline silicon ingot, according to claim 1, and an apparatus for producing a polycrystalline silicon ingot, according to claim 6 is provided. Other embodiments of the invention may be derived from the dependant claims.

During a process, a crucible is positioned in a process chamber, wherein the crucible is filled with solid silicon material in the process chamber. In this regard, the crucible is located with respect to a diagonal heater in such a way that the diagonal heater is located laterally offset and generally above the silicon ingot to be produced. In the following, the silicon material in the crucible is heated above its melting temperature while the process chamber is kept closed, thus producing molten silicon in the crucible, and afterwards, the molten silicon is cooled below the solidification temperature in the crucible, wherein during the cooling of the silicon, a temperature distribution in the silicon material is controlled at least partially via the at least one diagonal heater. The use of a diagonal heater and thus the introduction of heat in the molten silicon from a direction diagonal above allows for the formation of a flat phase boundary without using a top heater. In this way, the space above the molten material is open, and thus it is possible to provide e.g. a reloading unit. Furthermore, any direct gas flow from the crucible to the diagonal heater is blocked by means of at least one foil curtain which is provided adjacent to the side of the at least one diagonal heater which faces the crucible to protect the diagonal heaters with respect to possibly damaging fumes from the molten silicon.

In one embodiment of the invention, a plate element, located in the process chamber, is lowered above the crucible wherein the plate element comprises at least one passage for introducing a gas, and during at least one time segment, during the time of solidification of the molten silicon, a gas flow is directed to the surface of the molten silicon, wherein the gas flow is directed at least partially via the at least one passage in the plate element to the surface of the molten silicon. Of course, the gas flow may also be directed to the surface of the silicon located in the crucible during the heating and/or cooling process. Directing the gas to the surface of the molten silicon in the space formed between the surface and the plate element allows for a good adjustability of the cooling parameters and also allows for a good adjustability of the atmosphere at the surface of the molten material. The term time period of solidification of the molten silicon means the time period during which a phase change of the silicon from liquid phase to solid phase occurs. Further, the plate element may function as a passive heating element which is heated via the diagonal heater and thus similates a generally moveable top-heater.

Preferably, additional silicon material is fixed to the plate element before closing the process chamber, such that at least a part of the additional silicon material dips into the molten silicon in the crucible while lowering the plate element, thus melting the additional silicon material, which results in an increased level of the molten silicon in the crucible. In this way, the plate element also functions as an air direction element and also as a reloading unit.

In order to protect the diagonal heater against process gases from the area of the crucible, a top-bottom gas flow may be directed over at least one side of the diagonal heater facing the crucible during at least a portion of the heating and/or cooling process of the silicon material.

For a desired adjustment of the temperature profile in the silicon material, at least two diagonal heaters may be provided, one above the other, wherein the diagonal heaters are controlled at least during the cooling phase of the silicon material in such a way that they provide a heating power differing by at least 10%.

The apparatus, according to the invention, comprises a process chamber which may be opened and closed for loading and unloading, a crucible holder located in the process chamber for holding the crucible in a predetermined position, and at least one diagonal heater located in the process chamber. The diagonal heater is arranged in such a way that the diagonal heater is laterally positioned with respect to the crucible holder and is arranged generally perpendicularly to the crucible holder and is spaced from the crucible holder in the vertical direction at such a distance that the diagonal heater is generally located vertically above a polycrystalline silicon block or ingot which is to be formed in the crucible. Furthermore at least one foil curtain is provided adjacent to the side of the at least one diagonal heater which faces the crucible, in such a way that a direct gas flow from the crucible to the diagonal heater is blocked.

Further, the diagonal heater is stationary with respect to the crucible holder when the process chamber is closed. Such an apparatus provides for the benefits already mentioned above with respect to the process.

Preferably, a maximum of 20% of the diagonal heaters vertically overlaps with a crucible held by the crucible holder and/or a polycrystalline silicon ingot formed therein, in order to provide for heating of the silicon material from a direction diagonally above, especially during a cooling phase.

At least two stacked diagonal heaters may be provided for a convenient adjustment of the temperature profile in the process chamber and particularly in the silicon material. In this regard, preferably at least two of the stacked diagonal heaters comprise at least one resistance heating element, wherein vertically stacked heating elements comprise different resistances per unit of length, therein the resistance heating element having the higher resistance per unit of length comprises a resistance per unit of length of at least 10% higher than the resistance of the other resistance heating element. In this regard, the unit of length of the diagonal heater means the dimension in flow direction of the current. Preferably, the upper resistance heating element has the lower resistance per unit of length. Preferably, the vertically stacked diagonal heaters are connected to a shared controller unit via shared electrodes.

In one embodiment of the invention, the diagonal heater comprises a resistance heating element having straight sections and corner sections and surrounding the heating chamber, wherein the straight sections of the resistance heating element have a resistance per unit of length, which is preferably at least 10% higher than the resistance of the corner sections. The corner sections may be e.g. at least 10% thicker or wider compared to the straight sections. Furthermore, at least one diagonal heater may comprise a resistance heating element surrounding a heating chamber, the resistance heating element having straight sections and corner sections, wherein the corner sections are rounded.

According to a further embodiment, the following features are provided: a plate element arranged in the process chamber above the crucible holder, the plate element comprising at least one passage, at least one gas feeding tube extending in or through the at least one passage in the plate element, and at least one gas feeding unit located outside of the process chamber for feeding a gas flow into and through the gas feeding tube to a region below the plate element. By this means, controlled feeding or directing of a gas to the surface of the silicon material located in the crucible is facilitated during at least a portion of the process, thus providing the benefits already mentioned above.

Preferably, a lifting mechanism for lifting the plate element is provided, in order to be able to influence the gas flow and, where applicable, the temperature profile in the process chamber. Preferably, the plate element comprises means for attaching or holding silicon material in order to also function as a loading unit. Especially, the additional silicon material may be introduced only by moving the plate element into the molten silicon material, such that no additional guiding elements are necessary.

According to one embodiment of the invention, a film or foil carton is provided adjacent to one side of the at least one side of the diagonal heater facing the crucible, in order to be able to block a gas flow from the crucible to the diagonal heater. Gases detrimental to the heating unit are e.g. Si, SiO, or O, which may escape from the molten silicon. For protecting the diagonal heaters, means may be provided, which provide for a gas flow directed from top to bottom along the at least one diagonal heater, the means issuing a separate gas.

Preferably, at least one portion of at least one connecting electrode extends along a width dimension of the crucible. By this means, agitation of the molten material in the crucible may be induced. In this regard, the at least one portion extends adjacent to the upper third of a polycrystalline silicon ingot formed in the crucible.

### BRIEF DESCRIPTION OF THE DRAWINGS

In the following, the invention will be explained in more detail referring to the figures; in the figures:

FIG. 1 is a schematic sectional view of an apparatus for producing a polycrystalline silicon ingot in a crucible filled with silicon raw material;

FIG. 2 is a schematic view similar to FIG. 1, wherein the silicon raw material in the crucible is molten;

FIG. 3 is a schematic view similar to FIG. 2, wherein additional silicon raw material is immersed in the crucible;

FIG. 4 is a schematic view similar to FIG. 3 during a cooling phase;

FIG. 5 is a schematic view of an alternative apparatus for producing a polycrystalline silicon ingot by use of a silicon crucible filled with silicon raw material;

FIG. 6 is a schematic sectional view along line IV-IV in FIG. 4.

### DETAILED DESCRIPTION

In the following specification, terms such as top, bottom, left, and right and corresponding terms refer to the figures and shall not be regarded as limiting, wherein these terms refer to a preferred embodiment. The term generally, when used for angles and configurations shall enclose deviations of up to 10° and preferably up to 5°, except other ranges mentioned.

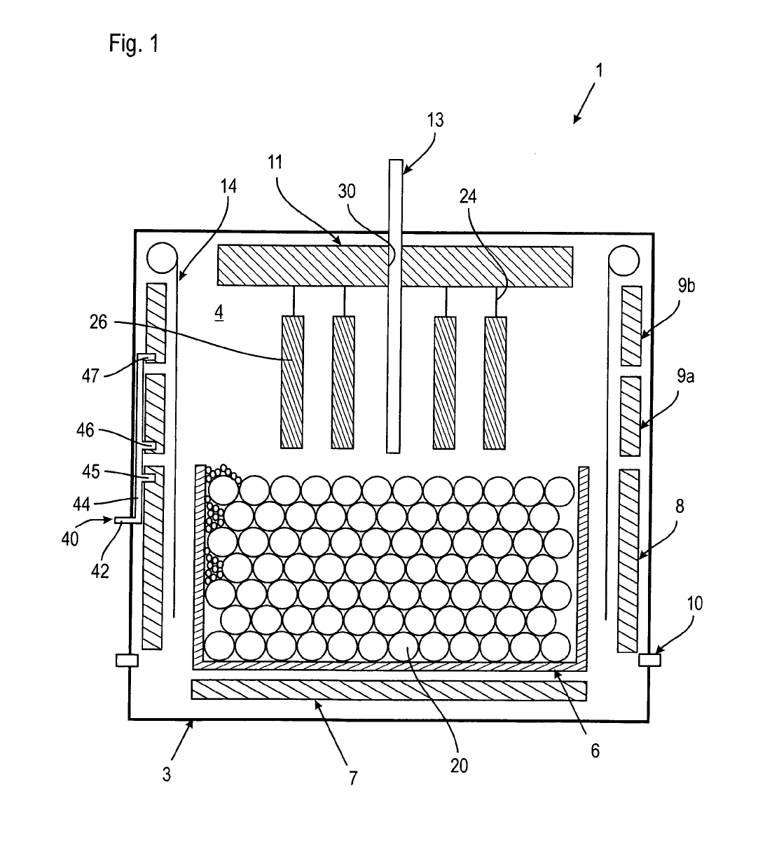

FIG. 1 shows a schematic sectional view of an apparatus 1 for producing a polycrystalline silicon ingot.

The apparatus 1 generally comprises an isolated box 3 defining a process chamber 4. In the process chamber 4, a holding unit (not shown in detail) for holding a crucible 6, a bottom heating unit 7, an optional lateral heating unit 8, as well as two stacked diagonal heating units 9a and 9b are provided. At least one gas outlet 10 is provided at the lower end of the lateral wall of the isolated box 3. A plate element 11 is provided above the holder for the crucible 6, further a gas feeding tube 13 is provided, the gas feeding tube 13 extending from above through the isolated box 3 and through the plate element 11 into the process chamber 4. Film or foil curtains 14 are provided adjacent to the diagonal heaters 9a, 9b and to a part of the lateral heaters 8, the foil curtains 14 being fixed above the highest diagonal heating unit 9b. The foil curtains are located at least partially in a space between the diagonal/lateral heating units 9a, 9b, 8, and the crucible 6.

The isolated box 3 is made of an appropriate isolating material, as is known in the art, and thus, the isolated box 3 is not described in detail. The process chamber 4 is connected to gas feeding and outlet tubes via means, which are not shown in detail, in order to adjust a determined process atmosphere in the process chamber 4. Except the gas feeding tube 13 and the gas outlets 10, these means are not shown in detail.

The crucible 6 is made of appropriate known material such as silicon-carbide, quartz, silicon-nitride, or a quartz coated with silicon-nitride, wherein the material does not affect the manufacturing process and is resistant to the high temperatures when fusing silicon material. Usually, the crucible 6 is destroyed already during the process by thermal expansion, and thus, the crucible 6 may be easily removed for withdrawal of the finished silicon ingot or block.

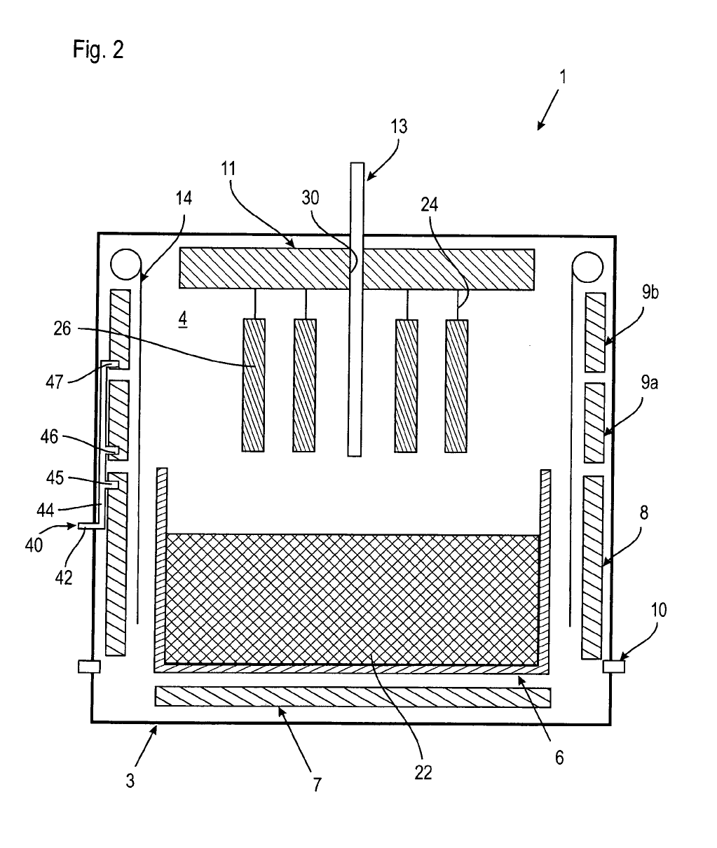

The crucible 6 forms a bowl open to the top, which may, as shown in FIG. 1, be filled with silicon raw material 20 up to the top edge. For filling of the crucible, e.g. silicon rods may be used, and the space in between is at least partially filled with broken silicon material, as shown on the left side in FIG. 1. By this means, a comparatively good degree of filling may be achieved, however some air pockets or space filled with air remain in the charged crucible. This results in the silicon material 20, when molten, not completely filling the crucible 6, as shown in FIG. 2, wherein the hatched region depicts molten silicon 22.

The bottom heating unit 7 is provided below or in a crucible holder and is thus located below the crucible 6 in case the crucible 6 is located in the process chamber. The optional lateral heating unit 8 radially surrounds the crucible 6 when the crucible 6 is located in the process chamber 4. The diagonal heating units 9a and 9b are located in a stacked manner above the lateral heating unit 8, and the diagonal heating units surround a region of the process chamber located above the crucible 6. Although the lower diagonal heating unit 9a is shown in such a way that it is entirely located above the crucible, it will be appreciated that the lower diagonal heating unit may also partially overlap with the crucible. In the following, a diagonal heating unit 9a is a heating unit at least partially surrounding a space above the crucible 6 in a radial direction and overlapping with the crucible 6 or with a silicon block or ingot formed therein a maximum of 20% and preferably a maximum of 10% of its height, respectively, in the vertical direction. A higher degree of overlap with the crucible 6 is possible, as long as no higher degree of overlap exists with the silicon ingot formed therein, since this crucible or molten silicon forming this crucible 6, respectively, forms the material which is to be diagonally heated (i.e. angularly from above). Of course, a diagonal heater may also be located entirely above the crucible 6, as is shown in FIG. 1.

Each of the heating units 7, 8, 9a, and 9b is the type of heating unit which is able to heat the process chamber 4 and especially the crucible 6 and the silicon raw material 20 located therein in an appropriate manner such that the raw material 20 melts and forms molten material or melt 22, as shown in FIG. 2.

The lateral heating unit 8 and the diagonal heating units 9a, 9b are formed by respective stacked heating bands, which may comprise markedly different resistances and may thus comprise markedly different heating powers. In this context, a difference wherein a higher resistance per unit of length is at least 10% higher than a lower resistance per unit of length, is looked upon as markedly differing. In this way, the relationship between the heated lateral area of the crucible or a silicon material located therein, respectively, and the surface of the silicon material facing the atmosphere, may be influenced in a specific manner, without being forced to use expensive, separately controllable heaters. Especially, different heating powers may be provided with the same control, such that a predetermined temperature profile may be adjusted or set in the process chamber 4. Especially, the upper diagonal heating unit 9b may be formed in such a manner that the upper diagonal heating unit 9b provides a higher heating power than the lower diagonal heating unit 9a, while being controlled in the same manner.

Each of the heating bands may be formed in one single piece or may be formed from a plurality of segments which are electrically connected, preferably in the area of electrodes 40a, 40b, and 40c (see FIGS. 1-5 and FIG. 6), which are provided for controlling the heating bands. As can be seen, three common electrodes, 40a, 40b, and 40c are provided for the lateral heater 8 and the diagonal heaters 9a and 9b, the electrodes 40a, 40b, and 40c being connected to an appropriate control unit for applying three-phase current to the reflective heating units 8, 9a, 9b. Providing a shared control unit and shared electrodes 40 for the diagonal heaters 9a, 9b, and also for the lateral heater 8, brings the special advantage that the amount of passages through the isolated box 3 may be reduced. By this means, the loss of heat in the region of the passages may be reduced. By use of a commonly used e.g. only one transformer is required, which reduces costs and error rate. Adjustment of a desired temperature profile in the process chamber 4 may be done via a corresponding adjustment of resistance values of the heating element, as will be specified in the following in more detail.

Two of the electrodes, 40a and 40b have a first section 42 respectively, which extends horizontally and through the isolated box 3, another adjacent, substantially horizontally extending section 43, which extends in the isolated chamber 3, substantially parallel to a lateral wall section of the crucible 6 another adjacent vertically extending section 44 as well as terminal sections 45, 46, and 47, extending from the vertical section 44. The terminal sections 45, 46, and 47 connect the vertical section 44 of the electrodes 40a and 40b to the lateral heater 8, the lower diagonal heater 9a and the upper diagonal heater 9b, respectively. The electrode 40 has a horizontal section which extends through the isolated box, and a vertically extending section directly adjacent thereto, as well as terminal sections extending from the vertical section.

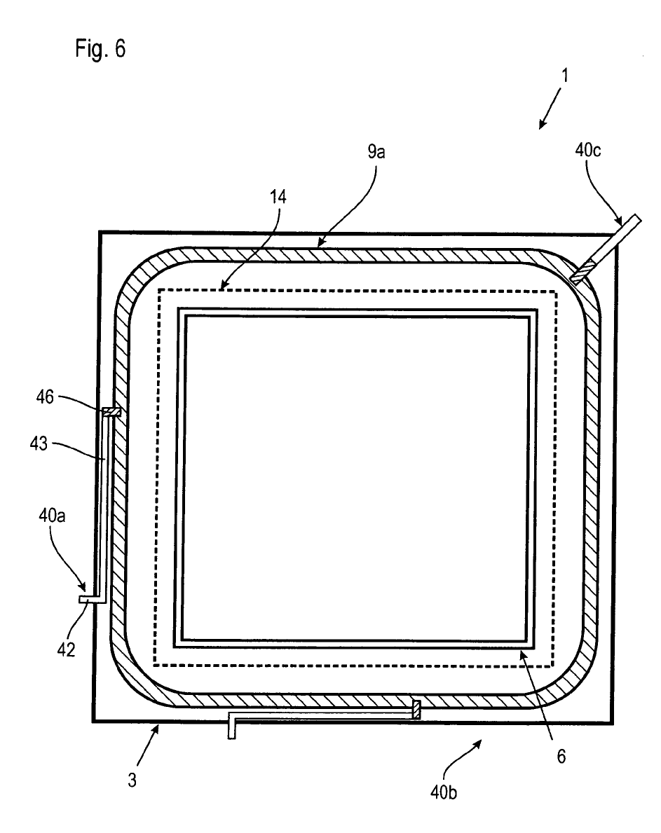

For each of the electrodes 40a, 40b, and 40c, only one passage through the isolated box 3 is required. Each of the electrodes 40a, 40b, and 40c may advantageously provide power to the lateral heater 8 as well as to the diagonal heaters 9a, 9b. The section 43 of the electrodes 40a and 40b (FIG. 6), which extends generally parallel to a lateral wall section of the crucible 6, may produce an advantageous magnetic steering action in molten material in the crucible due to the high current flowing therein. To this end, the sections 43 extend preferably adjacent to an upper third, and more preferably adjacent to an upper fourth, of a silicon ingot formed in the crucible 6. The vertically extending sections 44, and thus the terminal sections 45, 46, and 47, of the electrodes 40a, 40b, and 40c are generally arranged at the same angular distances around the circumference of the heating units 8, 9a, and 9b.

The heating bands of the lateral heating unit 8 and the diagonal heating units 9a and 9b have straight sections, respectively, which extend generally parallel to the side walls of the crucible 6, as well as corner sections, as can be seen in the view of FIG. 6. The straight sections and the corner sections may comprise markedly different distances per unit of length in the direction of the current (differing by at least ten percent), and may thus comprise different heating power. By this means, heat input to the corners of the crucible 6 and the silicon material therein, respectively, may be influenced in directed manner. For a decrease in heating power at the corners, a thicker end or wider heater may be used (e.g. graphite or CFC foil), alternatively additional components (e.g. from ISO or continuous casted graphite) may be employed, which markedly lower the overall heating resistance at the corners. The corner sections may be rounded, as indicated in FIG. 6, in order to avoid corner connections prone to deterioration and faults and tending to overheat.

Should low cost graphite foils be used as heating bands, these graphite foils need to be mechanically stabilized against deflection. In this regard, vertical fixing ridges made from electrically isolating material (e.g. silicon nitride) may be employed since thus, no compensating currents may flow between different heating bands, and the heating bands may move vertically, but may not move horizontally or twist.

Should CFC heating bands be used, pre-fabricated form elements especially adapted to the required geometry may be used, such as heating bands rounded at the corners. Such a heating band may be manufactured from one piece or may be divided into segments (e.g. three segments) which may be advantageously clamped and contacted at the electrodes. The mounting and maintenance effort is markedly reduced in this manner.

The characteristics and features discussed above with respect to the lateral heating unit 8 and the diagonal heating units 9a and 9b are advantageous existing independent of the use of diagonal heaters and, thus, apply to systems without diagonal heaters.

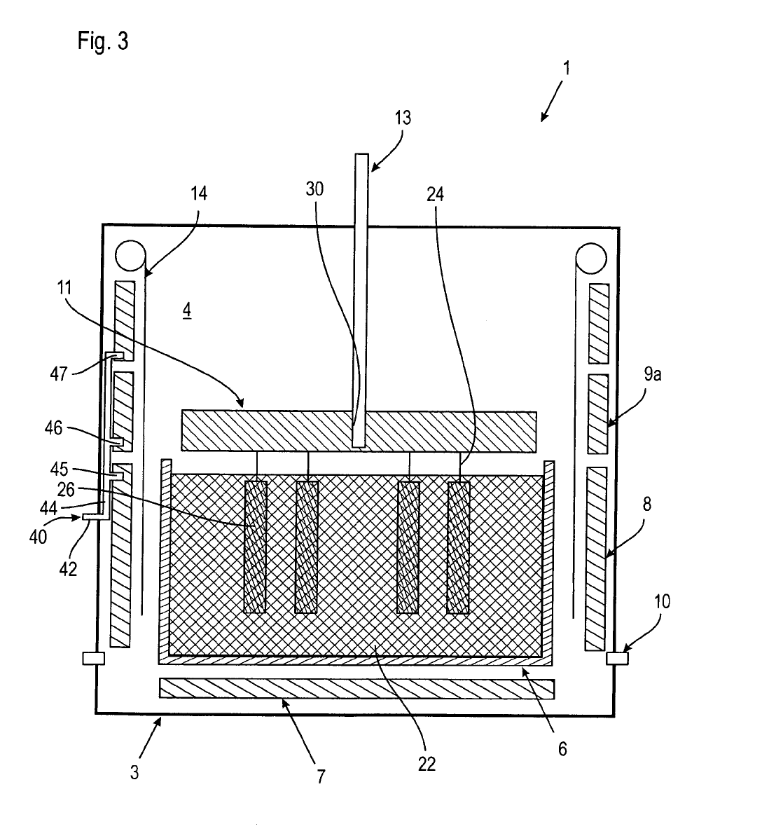

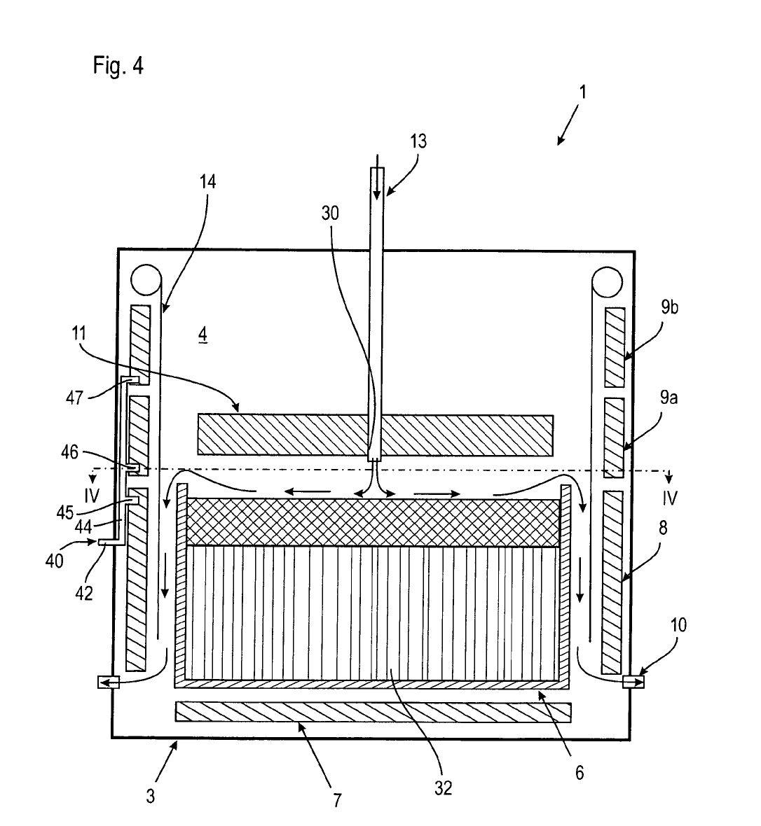

The plate element 11 located above the crucible 6 is made of appropriate material which does not melt at the temperatures used for melting the silicon raw material and which does not introduce pollution into the process. Furthermore, the plate element is made of a material which may be easily heated via the diagonal heating units 9a, 9b in a passive manner. The plate element 11 may be raised and lowered via a mechanism (not shown in detail) inside the process chamber, as will be specified in more detail with respect to FIGS. 3 and 4. At the bottom side of the plate element 11, holding units 24 are provided, which are able to hold additional silicon raw material, such as silicon rods 26, below the plate element 11. In the arrangement according to FIG. 1, four silicon rods 26 are shown, which are located in one row below the plate element 11. As may be obvious to the person skilled in the art, additional such holding elements are provided across the depth (i.e. perpendicular to the layer of the drawings), wherein additional holding elements are provided to hold additional silicon rods 26.

Furthermore, the holding elements 24 may also carry silicon raw material in the form of disks or rod sections of varying lengths. The holding elements are shown as simple rods, e.g. threadably connected to the silicon rods. Furthermore, the holding elements may also be grippers or other elements adapted to carry the silicon rods 26. Again, the holding elements should be made from temperature-resistant material which does not pollute the molten silicon.

The plate element 11 has a circumferential form approximately corresponding to the inner circumference of the crucible 6. Further, the plate element has a middle passage 30 through which the gas heating tube 13 extends.

The gas feeding tube 13 is made from an appropriate material such as graphite. The gas feeding tube extends from the process chamber 4 through the isolated box 3 to the outside and is connected to an appropriate gas supply, e.g. for Argon. A gas may be fed to the process chamber 4 via the gas feeding tube 13, as will be explained below in more detail. The gas feeding tube 13 may provide for guiding of the plate element 11 during raising or lowering of the plate element.

Fixing elements for foil curtains 14 are indicated above the upper diagonal heating unit 9b (FIG. 1). The foil curtains 14 connected thereto extend to a region between a space above the crucible and the diagonal heating units 9a, 9b, and between the lateral heating unit 8 and the crucible 6, as is shown in FIGS. 1-4. Additionally, the foil curtains may also at least partially cover the top area of the process chamber 4 (FIG. 6). The foil curtains 14 are made of temperature resistant gas-tight material, which does not admit undesired pollutions into the process chamber, such as graphite foil. The foil curtains 14 may also extend directly from the ceiling of the isolated box 3 and may be sealed thereto. It is also possible that the foil curtains are sealed to a side wall of the isolated box 3 at their lower ends, thus forming a sealed space for holding the side/diagonal heaters.

The operation of apparatus 1 will be explained in the following in more detail with respect to FIGS. 1 and 4, wherein each of the figures show the same apparatus during different process steps.

FIG. 1 shows the apparatus 1 prior to the beginning of the production process itself. The crucible 6 is filled with a silicon raw material 20 up to its upper edge. In the figure, silicon rods and granulated silicon have been used for filling the crucible 6. Silicon rods 26 are fixed to a plate element 11 via the holding elements 24.

After the apparatus 1 has been prepared in such a way, the silicon raw material 20 is molten in the crucible 6 via heat input by the bottom heating unit 7, the lateral heating unit 8, and the diagonal heating units 9a, 9b. The heating units 7, 8, 9a, and 9b are controlled during this process in such a way that heat input primarily happens from below, such that the silicon rods 26 being held above the crucible 6 via the plate element 11, will be warmed but not fused.

After the silicon raw material 20 has become completely molten, molten silicon or silicon melt 22 is formed in the crucible 6, as is shown in FIG. 2. The silicon rods 26 fixed to the plate element 11 are not molten at this point in time. Thereafter, the plate element 11 is lowered via the lifting mechanism (not shown in detail) in order to immerse the silicon rods 26 into the molten silicon 22, as is shown in FIG. 3. In this way, the filling level of the molten silicon 22 in the crucible is raised substantially, as may be seen in FIG. 3. The immersed silicon rods 26 are completely melted and mixed with the molten material 22, due to the contact with the molten silicon 22 due to the additional heat input provided by the bottom heaters 7 and the lateral heaters 8.

In the following, the plate element may be maintained in the position according to FIG. 3 as long as the holding elements 24 do not contact the molten silicon 22. In case the holding elements contact the molten silicon, the plate element 11 will be raised slightly in order to lift the holding elements 24 from the molten material 22, as is shown in FIG. 4.

At this point in time, the heat input by the heating units may be reduced substantially or may be switched off in order to achieve cooling of the molten silicon 22 in the crucible 6. In doing so, the cooling is controlled especially via the diagonal heating units 9a, 9b in such a way that the solidification of the molten material 22 occurs from the bottom to the top in a directed manner. A shallow or flat phase boundary between the molten silicon 22 and the solidified portion 32 may be achieved via controlling the diagonal heaters 9a, 9b, as can be seen in FIG. 4. FIG. 4 shows the point in time during the process during which the lower part 32 of the silicon material in the crucible is solidified, while molten silicon 22 still exists on top. The flat phase boundary is achieved by the diagonal heaters 9a, 9b in combination with the plate element 11, simulating a top-heater and thus facilitating a temperature in the silicon material located in the crucible 6, being horizontally, substantially at the same temperature. This situation may, of course, also be attained without the plate element 11, since the diagonal heaters heat the silicon material in the crucible 6 diagonally or angularly from above. Thus, the plate element 11 is an advantageous but optional feature and may be omitted and may, as appropriate, be replaced by another reloading unit.

At one point in time during the process and especially at the beginning and during the melting phase, a gas inert to the silicon, such as Argon, is directed to the surface of the molten silicon 22 via the gas feeding tube 13. The gas flows over the surface of the molten silicon 22 to the outside and thereafter, between the crucible 6 and the foil curtain 14 to the gas outlet 10, as may be seen in FIG. 4. The foil curtain 14 functions as a protection for the diagonal heating units 9a, 9b, and the lateral heating unit 8 against a contact with the gas which is directed over the surface of the molten silicon and thus comprises gaseous silicon, SiO, or oxygen.

The diagonal heating unit 9a, 9b and the lateral heating unit 8 may optionally be surrounded by additional gas, which is e.g. introduced separately between the foil curtain 14 and the isolated box 3, wherein the additional gas does not chemically react with the material of the heating units 8, 9a, 9b, or with the gas flow directed from the surface of the molten silicon (e.g. Argon or another inert gas). In this way, gas, which was directed over the molten silicon 22 and comprising gaseous silicon, is prevented from reaching the heating units 8,9a, 9b. The additional gas directed over the heating units 9a, 9b, 8 as well as the gas directed over the molten silicon 22 may be discharged via the gas outlets 10.

Once the molten silicon 22 is completely solidified, a silicon ingot is formed in the crucible 6, the silicon ingot being the final product. The ingot may be further cooled down to a handling temperature in the process chamber 4 before the ingot is removed from the process chamber 4.

During the melting of the silicon material and the subsequent cooling process, as was described above, the heating units 8, 9a, and 9b may be controlled e.g. in such a way that the heating units contribute to about 10%, 30%, and 60%, respectively, to the heating power provided laterally/diagonally. This may be achieved via individual control of the units or via the inherent construction of the units, having different resistances, wherein a shared control may be provided in the latter case.

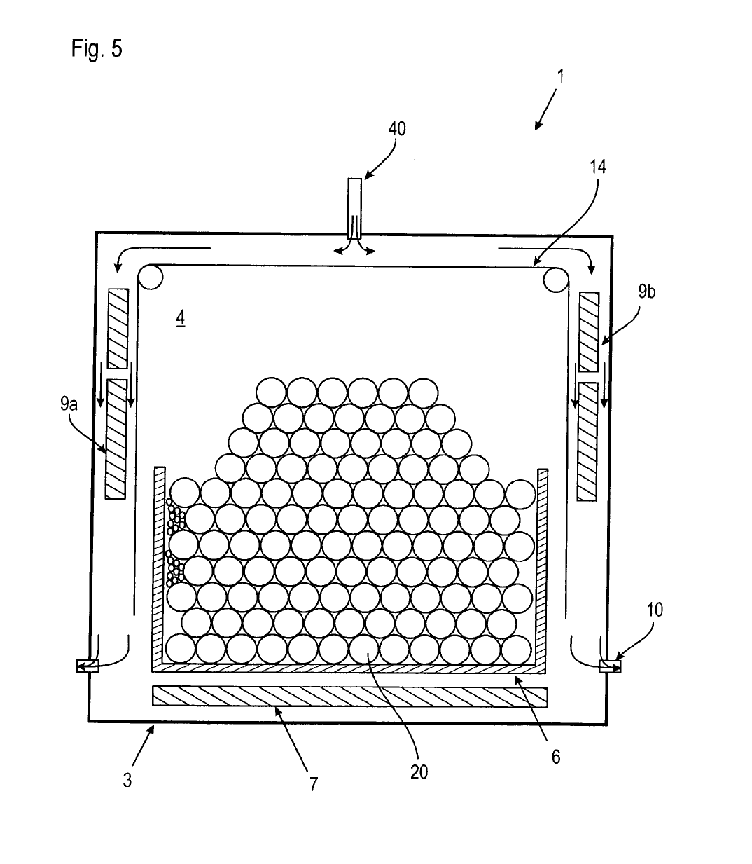

FIG. 5 shows an alternative embodiment of an apparatus 1 for producing a polycrystalline silicon ingot, according to the present invention. The same reference signs are used in FIG. 5 to the degree that the same or similar elements are described.

Again, the apparatus 1 consists basically of an isolated box 3 which forms a process chamber 4 inside. A holder for a crucible 6 is provided in the process chamber 4. Furthermore, a bottom heating unit 7 and diagonal heating units 9a and 9b are provided in the process chamber. However, a lateral heating unit is not provided in this embodiment. Gas outlet guides 10 are provided in a lower region of the isolated box. Furthermore, a foil curtain 14 is provided in the process chamber 4. A gas supply 40 is provided in the upper surface of the isolated box 3. A plate element, as was provided in the first embodiment, is not provided in this embodiment, but may optionally be provided.

Again, the crucible is filled with silicon raw material 20, wherein the silicon raw material 20 is stacked over the upper edge of the crucible 6, primarily in the form of rod material, in order to achieve a desired filling level of molten silicon in the crucible 6 after the melting process. In this way, a reloading unit may be omitted. Instead of stacking the rod material as shown, it is also possible to arrange the rod material generally vertically in the crucible. Up to the height of the crucible, spaces may be filled with broken silicon, as mentioned above. In order to avoid silicon material falling over the edge of the crucible 6, an auxiliary wall may be provided for the crucible, wherein the auxiliary wall may be used several times.

The bottom heating unit 7 may have the same construction as was described above, which is also true for the diagonal heating units 9a, 9b. In the shown embodiment, the lower diagonal heating unit 9a is made longer than the crucible and partially overlaps the crucible and a silicon ingot which may be located therein. In this regard, overlapping of the crucible or the silicon ingot, respectively, should be a maximum of 20% of the length of the diagonal heater.

The foil curtain 14 may consist of the same material as described above and also extends at least partially along the upper region of the isolated box 3. The foil curtain 14 covers the crucible similar to a canopy or baldachin, wherein the diagonal heating units 9a, 9b are not located in the covered region. A gas flow may be fed into the process chamber 4 via the gas supply 40, wherein the gas flow is directed over the diagonal heating units 9a, 9b by the foil curtain 14, in order to protect the diagonal heating units 9a, 9b against process gases from the region of the crucible 6.

The process generally resembles the process described above wherein no plate element is provided for reloading and wherein heating of the silicon material is exclusively provided via the bottom heating units 7 and the diagonal heating units 9a and 9b.

The invention has been described above in more detail with the help of preferred embodiments of the invention without being limited to the particular embodiments. It should be noted that elements of the different embodiments may be combined with each other or that elements may be exchanged in the different embodiments. It would be optional to provide a gas curtain instead of a foil curtain, the gas curtain being formed by a gas flow directed from the top to the bottom and thus protecting the diagonal heater against detrimental process gases.

1. A process for producing polycrystalline silicon ingots, wherein the process comprises the following steps:
placing a crucible in a process chamber, wherein the crucible is filled with solid silicon material or is filled with silicon material in the process chamber, wherein the crucible is arranged with respect to at least one diagonal heater in such a way that the diagonal heater is laterally offset and generally above the silicon ingot to be produced;
heating the solid silicon material in the crucible above the melting temperature of the silicon material in order to form molten silicon in the crucible;
cooling the silicon material in the crucible below the solidification temperature of the molten silicon, wherein a temperature distribution in the silicon material during the cooling step is controlled at least partially via the at least one diagonal heater; and
blocking any direct gas flow from the crucible (6) to the diagonal heater (9a, 9b) by means of at least one foil curtain (14) which is provided adjacent to the side of the at least one diagonal heater (9a, 9b) which faces the crucible.

2. The process according to claim 1 further comprising:
lowering a plate element located in the process chamber and being passively heated via the at least one diagonal heater and comprising at least one passage for a gas supply; and
directing a gas flow to the surface of the molten silicon in the crucible during at least a time segment of the time period of solidification of the molten silicon, wherein the gas flow is directed to the surface of the molten silicon at least partially via the at least one passage in the plate element.

3. The process according to claim 2, which further comprises:
fixing additional solid silicon material to the plate element before heating of the silicon material in the crucible in such a way that at least a part of the additional fixing additional solid silicon material to the plate element before heating of the silicon material in the crucible in such a way that at least a part of the additional silicon material is immersed into the molten silicon in the crucible during the lowering of the plate element, thus melting, whereby the filling level of the molten silicon in the crucible is raised.

4. The process according to claim 1, which further comprises:
directing a top-bottom gas flow over at least one side of the diagonal heater facing the crucible during at least a section of the heating and/or cooling step of the silicon material.

5. The process according to claim 1, wherein at least two stacked diagonal heaters are provided, the diagonal heaters being controlled at least during the step of the cooling of the silicon material in such a way that the diagonal heaters emit a heating power differing by at least 10%.

6. An apparatus (1) for producing a polycrystalline silicon ingot comprising:
a process chamber (4) which may be opened and closed for loading and unloading;
a crucible holder inside the process chamber (4) for holding a crucible (6) in a predetermined position;
at least one diagonal heater (9a, 9b) located in the process chamber (4) laterally with respect to the crucible holder, the diagonal heater being generally perpendicular thereto and being spaced from the crucible holder in the vertical direction at such a distance that the diagonal heater (9a, 9b) is vertically located generally above a polycrystalline silicon ingot, to be formed in the crucible, and wherein the diagonal heater (9a, 9b) is stationary relative to the crucible holder while the process chamber is closed; and
at least one foil curtain (14) which is provided adjacent to the side of the at least one diagonal heater (9a, 9b) which faces the crucible, in such a way that a direct gas flow from the crucible (6) to the diagonal heater (9a, 9b) is blocked.

7. The apparatus, according to claim 6, wherein a maximum of 20% of the diagonal heater (9a) vertically overlaps a crucible held by the crucible holder and/or a polycrystalline silicon ingot formed therein.

8. The apparatus, according to claim 6, wherein at least two stacked diagonal heaters (9a, 9b) are provided.

9. The apparatus, according to claim 8, wherein at least two of the stacked diagonal heaters (9a, 9b) comprise at least one resistance heating element wherein the stacked resistance heating elements comprise differing resistances per unit of length, wherein the resistance heating element having the higher resistance per unit of length comprises a resistance per unit of length at least 10% higher than the resistance per unit of length of the other resistance heating element.

10. The apparatus, according to claim 9, wherein the upper resistance heating element has the lower resistance per unit of length.

11. The apparatus, according to claim 9, wherein the stacked diagonal heaters (9a, 9b) are connected via shared electrodes to a shared control unit.

12. The apparatus, according to claim 6, wherein the diagonal heater (9a, 9b) comprises a resistance heating element having straight sections and corner sections and surrounding a heating space, wherein the straight sections have a resistance per unit of length which is at least 10% higher than the resistance per unit of length of the corner sections.

13. The apparatus, according to claim 6, wherein the diagonal heater (9a, 9b) comprises a resistance heating element having straight sections and corner sections and surrounding a heating space, wherein the corner sections are rounded.

14. The apparatus, according to claim 6, further comprising at least one plate element (11) arranged in the process chamber above the crucible holder, the plate element comprising at least one passage (30); at least one gas feeding tube (13) extending in or through the at least one passage (30) and the plate element (11); and at least one gas feeding unit outside the process chamber (4) for feeding a gas flow in and through the gas feeding tube in a region below the plate element (11).

15. The apparatus, according to claim 14, wherein a lifting mechanism is provided for the plate element (11).

16. The apparatus (1) according to claim 14, wherein the plate element (11) comprises means for fixing silicon material (26).

17. The Apparatus (1) according to claim 6 wherein means (14, 40) are provided for producing a top-bottom gas flow along the at least one diagonal heater (9a, 9b).

18. The apparatus (1), according to claim 6, wherein at least one terminal electrode (40a, 40b) having a section (43) extends along a width dimension of the crucible width.

19. The apparatus (1), according to claim 18, wherein the at least one section (43) of the terminal electrode (40a, 40b) extends adjacent to an upper third of a polycrystalline silicon ingot formed in the crucible (6).
